(19) United States
(12) Patent Application Publication
(10) Pub. No.: US 2014/0197640 A1
(43) Pub. Date: Jul. 17, 2014

(54) HYDROELECTRIC POWER GENERATING SYSTEM

(71) Applicant: YASER K. BARAKAT, ROANOKE, VA (US)

(72) Inventor: YASER K. BARAKAT, ROANOKE, VA (US)

(21) Appl. No.: 14/156,408

(22) Filed: Jan. 15, 2014

Related U.S. Application Data
(60) Provisional application No. 61/753,302, filed on Jan. 16, 2013.

(51) Int. Cl. F03B 13/08

(52) U.S. Cl. CPC F03B 13/08
USPC 290/54

(57) ABSTRACT

The hydroelectric power generating system incorporates a man-made dam structure configured to completely enclose a body of water. The dam is preferably filled by pumping seawater into the reservoir defined by the encircling dam. A circumferential canal feeds water to one or more penstocks. Each penstock has one or more hydroelectric turbine generators installed therealong. The penstocks feed an enclosed circumferential channel about the base of the dam. The channel delivers water to a pump that pumps the water back into the bottom of the reservoir. While this system results in a net loss of energy, the system can make use of surplus power to drive the return pump during periods of low electrical demand in order to replenish the reservoir.

### CROSS-REFERENCE TO RELATED APPLICATION

This application claims the benefit of U.S. Provisional Patent Application Ser. No. 61/753,302, filed Jan. 16, 2013.

### BACKGROUND OF THE INVENTION

1. Field of the Invention

The present invention relates to electrical power generating systems, and particularly to a hydroelectric power generating system incorporating man-made reservoirs that each have one or more penstocks extending from a common waterway and one or more electrical generating turbines disposed along each of the penstocks.

2. Description of the Related Art

Hydroelectric power generating systems have been known for a considerable period of time. Conventional systems utilize a natural geographic basin, valley, or the like, and place a man-made dam across a channel in the natural terrain to create a reservoir upstream of the dam. The water is then made to flow through one or more power generating turbines in the dam (or in a powerhouse constructed with the dam), to generate electrical power. Generally, only a single generating turbine is installed in each penstock of the facility, although multiple penstocks are common in a single conventional hydroelectric power generating system.

An example of such a conventional hydroelectric power generating system is found in Japanese Patent Publication No, 9-177,654, published on Jul. 11, 1997. This reference describes (according to the drawings and English abstract) a hydroelectric power generating system incorporating a single penstock run with multiple generating turbines installed therealong. One embodiment is illustrated having an upstream reservoir and dam and a second downstream reservoir and dam, and generating turbines installed downstream of each dam.

Another example is found in Chinese Patent Publication No. 2,880,912 published on Mar. 21, 2007 to Wu Jinnan. A plurality of generating turbines is installed in series along stepped concrete bases downstream of the dam.

Thus, a hydroelectric power generating system solving the aforementioned problems is desired.

### SUMMARY OF THE INVENTION

The hydroelectric power generating system comprises a man-made dam structure that completely encircles a water reservoir enclosed therein. The water may be pumped from the sea. The man-made dam structure and transport of the water enables the hydroelectric power generating system to be constructed virtually anywhere, so long as there is sufficient land available for the facility. The dam may be substantially circular, or may have any other desired configuration. At least one sluice gate, and preferably a plurality of such gates, feeds a peripheral canal near the top of the dam. The peripheral canal, in turn, feeds at least one penstock, and preferably a plurality of such penstocks. Each penstock includes at least one electrical generating turbine, and preferably a plurality of such turbines, therealong. The downstream end of the penstock or penstocks feed into an enclosed circumferential channel within the base of the dam. A return line extends from the channel through the base of the dam and into the reservoir. A pump is installed in the return line, enabling water to be pumped from the return line back into the reservoir. While this system results in a net loss of energy, it does enable the reservoir to be replenished during periods where surplus electrical energy is available.

The system uses water to generate essentially “clean” energy. Construction of a sufficient number of such facilities, and/or of sufficient water volume, would result in some slight reduction in sea level as water is drawn from the oceans to the reservoirs. The reservoirs would also serve as convenient water recreational sites, as any number of such facilities could be constructed convenient to large population centers, as opposed to conventional hydroelectric dams and their reservoirs. The hydroelectric power generating system would make use of salt water from the sea, rather than fresh water. The dissolved salt and minerals in the water may prove to be of some benefit to some individuals. Also, it is anticipated that the relatively large volume of ocean water captured within the dams would provide a practical environment for the farming of many ocean-dwelling fish and other marine life, as well as serving to protect endangered species of marine life.

These and other features of the present invention will become readily apparent upon further review of the following specification and drawings.

### BRIEF DESCRIPTION OF THE DRAWINGS

FIG. 1 is a diagrammatic perspective view of a hydroelectric power generating system according to the present invention, illustrating its general features.

FIG. 2 is a diagrammatic elevation view in section of the hydroelectric power generating system according to the present invention, illustrating further details thereof.

Similar reference characters denote corresponding features consistently throughout the attached drawings.

### DETAILED DESCRIPTION OF THE PREFERRED EMBODIMENTS

The hydroelectric power generating system greatly expands upon the availability of conventional hydroelectric power systems, using a relatively small man-made dam extending across a natural channel to form a reservoir enclosed by natural terrain. While such facilities are quite valuable for the power they produce, as well as for their recreational and flood control benefits, the number of such facilities is limited by the lack of availability of natural terrain permitting their construction and efficient operation.

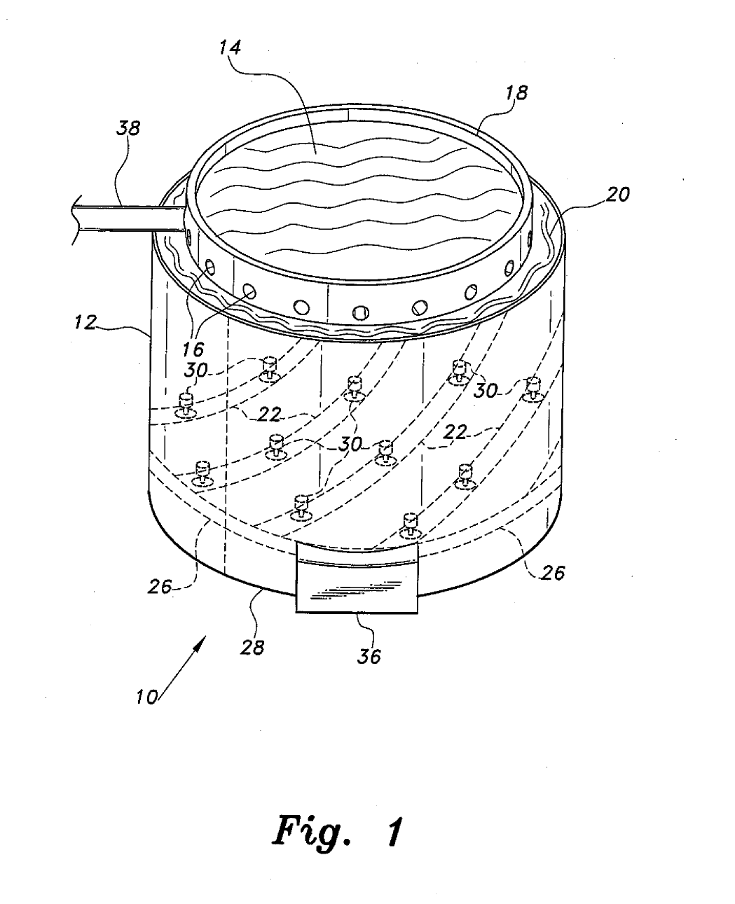

FIG. 1 of the drawings provides a diagrammatic perspective view of an exemplary hydroelectric power generating system 10 according to the present invention. The system 10 incorporates a relatively large dam 12 or wall defining a dam that completely encircles or laterally encloses a reservoir 14 therein. The dam 12 may have a generally cylindrical configuration, as shown in FIG. 1, or may have any other desired external shape or configuration. The dam 12 includes at least one sluice gate 16 (and preferably a plurality of sluice gates 16) extending through the upper portion 18 thereof. The sluice gates 16 permit the flow of water from the upper levels of the reservoir 14 through the dam 12 and into an externally disposed peripheral canal 20 that surrounds the upper portion 18 of the dam 12.

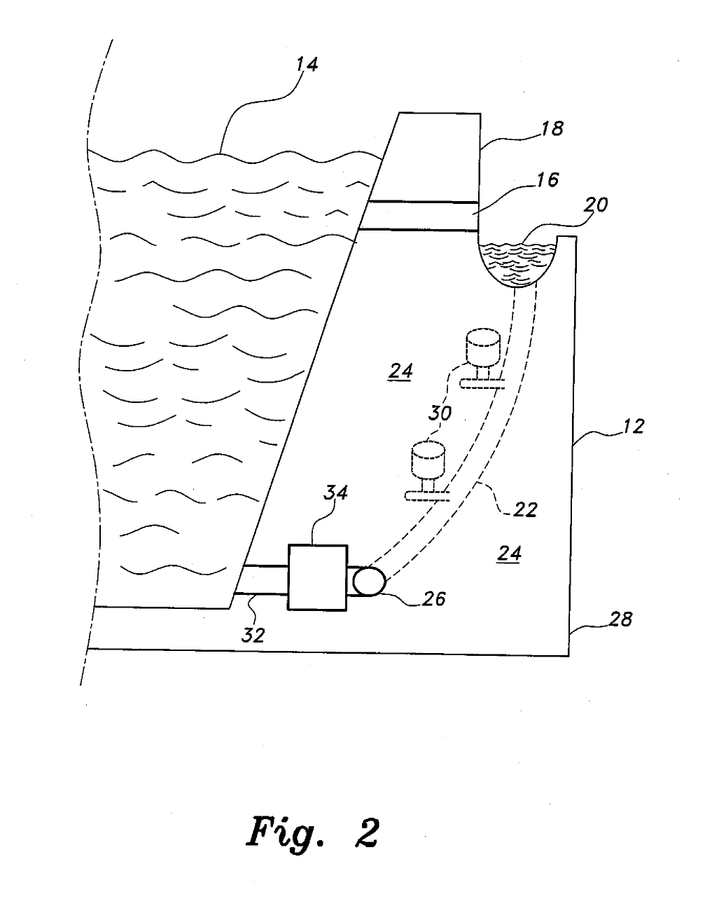

At least one penstock 22 (preferably a plurality of penstocks 22) extends from the peripheral canal 20 downward through the interior 24 of the dam 12 to an internal collection channel 26 disposed within the base 28 of the dam 12. The penstocks 22 do not descend vertically within the internal structure 24 of the dam 12, but describe helical arcs as each of the penstocks 22 traverses a portion of the circumference of the dam 12, generally as illustrated in FIGS. 1 and 2 of the drawings. Each penstock 22 includes at least one (and preferably a plurality of) hydroelectric turbine generator 30 installed therealong. The installation of a plurality of generators 30 in each penstock 22 provides additional power recovery from the energy developed by the water as it continues to flow through the penstock from the uppermost generator 30.

Water flows from the upper level of the reservoir 14 through the sluice gates 16 and into the peripheral upper canal 20. Water flow through the sluice gates 16 may be controlled by conventional gate valves or the like. The water then flows downward through the penstocks 22 to operate the generators 30 for electrical power generation. Each of the penstocks 22 may also include a conventional gate valve or other water control or shutoff device. The water then flows from the lower ends of the penstocks 22 into the internal collection channel 26 within the interior 24 of the base 28 of the dam 12. A return passage 32 extends from the collection channel 26 and the lower level of the reservoir 14, as shown in FIG. 2. As water seeks its own level, it will be seen that there will be no net flow through the system when the water level in the reservoir volume 14 is equal to the water level in the peripheral canal 20. However, a pump 34 is provided in or along the return passage 32 to deliver water from the collection channel 26 back into the reservoir volume 14. While only a single return passage 32 and pump 34 are shown, it will be understood that a plurality of return passages and pumps may be provided, if desired. While the power required to operate the pump 34 is greater than the power generated by the hydroelectric turbine generators 30, the pump 34 may be operated at times of low electrical power demand to enable the hydroelectric power generating system 10 to function. A powerhouse 36 is provided external to the base 28 of the dam 12 to control and distribute electrical power generated by the system, and to control and operate the pump 34 as well.

The system 10 as described above is a closed system, i.e., water is not permitted to escape the system, except by evaporation and/or leakage. This is because the water to be used in the system 10 is taken from the sea, i.e., it is salt water unsuited for irrigation or potable consumption. The salt water is pumped from a suitable oceanic source through a seawater delivery line 38 that communicates with the reservoir 14, as shown in FIG. 1, to fill the reservoir volume 14 initially. The use of seawater with the hydroelectric power generation system 10 may provide a number of benefits. The construction of a large number of very large systems on otherwise unusable land (desert, etc.) could accept a small percentage of the water of the present oceans and seas of the planet, and thereby reduce the rising sea level trend that has developed, at least to some small extent. The recreational value of such installations when constructed near large population centers has been noted further above. Some persons may find that swimming or bathing in the salt water may provide certain benefits, and the construction of such systems convenient to their homes serves to facilitate access. The relatively large volume of salt water contained by very large dams 12, or by a series of such dams 12, will provide support for a large number of fish and other marine animals. These fish and/or marine animals may be harvested for edible consumption, and/or the reservoir volumes may serve as habitats for endangered species. Accordingly, the present hydroelectric power generating system provides a number of benefits in addition to potential power production.

It is to be understood that the present invention is not limited to the embodiments described above, but encompasses any and all embodiments within the scope of the following claims.

1. A hydroelectric power generating system, comprising:
a dam having an upper portion, a base, and an interior;
a reservoir enclosed laterally by the dam, the dam completely surrounding and defining the reservoir therein;
at least one sluice gate disposed in the upper portion of the dam;
a peripheral canal disposed about the upper portion of the dam, the reservoir selectively communicating with the canal through the at least one sluice gate;
at least one penstock extending from the canal, the penstock being disposed within the interior of the dam; and
a plurality of hydroelectric turbine generators disposed along the penstock.

2. The hydroelectric power generating system according to claim 1, wherein:
said at least one sluice gate comprises a plurality of sluice gates disposed in the upper portion of the dam; and
said at least one penstock comprises a plurality of penstocks extending from the canal.

3. The hydroelectric power generating system according to claim 1, further comprising:
a collection channel disposed within the base of the dam, the collection channel communicating with the penstock;
a return passage disposed in the base of the dam between the collection channel and the reservoir, the return passage defining a fluid conduit extending from the collection channel communicating to the reservoir; and
a return pump disposed in the return passage.

4. The hydroelectric power generating system according to claim 1, further comprising a sea water delivery line communicating with the reservoir.

5. The hydroelectric power generating system according to claim 1, further comprising a power house disposed at the base of the dam.

6. The hydroelectric power generating system according to claim 1, wherein the peripheral canal is disposed externally about the upper portion of the dam.

7. The hydroelectric power generating system according to claim 1, wherein:
the dam is substantially cylindrical; and
the at least one penstock defines a helical arc.

8. A hydroelectric power generating system, comprising:
a dam having an upper portion, a base, and an interior;
a reservoir enclosed laterally by the dam, the dam completely surrounding and defining the reservoir therein;
a plurality of sluice gates disposed in the upper portion of the dam;
a peripheral canal disposed about the upper portion of the dam, the reservoir selectively communicating with the canal through the sluice gates;
a plurality of penstocks extending from the canal, the penstocks being disposed within the interior of the dam; and
at least one hydroelectric turbine generator disposed in each of the penstocks.

9. The hydroelectric power generating system according to claim 8, wherein said at least one hydroelectric turbine generator comprises a plurality of hydroelectric turbine generators disposed in each of the penstocks.

10. The hydroelectric power generating system according to claim 8, further comprising:
a collection channel disposed within the base of the dam, the collection channel communicating with the penstock;
a return passage disposed in the base of the dam between the collection channel and the reservoir, the return passage defining a fluid conduit extending from the collection channel communicating to the reservoir; and
a return pump disposed in the return passage.

11. The hydroelectric power generating system according to claim 8, further comprising a sea water delivery line communicating with the reservoir.

12. The hydroelectric power generating system according to claim 8, further comprising a power house disposed at the base of the dam.

13. The hydroelectric power generating system according to claim 8, wherein the peripheral canal is disposed externally about the upper portion of the dam.

14. The hydroelectric power generating system according to claim 8, wherein:
the dam is substantially cylindrical; and
each of the penstocks defines a helical arc.

15. A hydroelectric power generating system, comprising:
a dam having an upper portion, a base, and an interior;
a reservoir enclosed laterally by the dam, the dam completely surrounding and defining the reservoir therein;
at least one sluice gate disposed in the upper portion of the darn;
a peripheral canal disposed about the upper portion of the dam, the reservoir selectively communicating with the canal through the at least one sluice gate;
at least one penstock extending from the canal, the penstock being disposed within the interior of the dam;
at least one hydroelectric turbine generator disposed in the at least one penstock;
a collection channel disposed within the base of the dam, the collection channel communicating with the penstock;
a return passage disposed in the base of the dam between the collection channel and the reservoir, the return passage defining a fluid conduit extending from the collection channel communicating to the reservoir; and
a return pump disposed in the return passage.

16. The hydroelectric power generating system according to claim 15, wherein said at least one hydroelectric turbine generator comprises a plurality of hydroelectric turbine generators disposed in the at least one penstock.

17. The hydroelectric power generating system according to claim 15, wherein:
said at least one sluice gate comprises a plurality of sluice gates disposed in the upper portion of the dam; and
said at least one penstock comprises a plurality of penstocks extending from the canal.

18. The hydroelectric power generating system according to claim 15, further comprising a sea water delivery line communicating with the reservoir.

19. The hydroelectric power generating system according to claim 15, further comprising a power house disposed at the base of the dam.

20. The hydroelectric power generating system according to claim 15, wherein:
the peripheral canal is disposed externally about the upper portion of the dam;
the dam is substantially cylindrical; and
the at least one penstock defines a helical arc.
